(19) United States
(12) Patent Application Publication
(10) Pub. No.: US 2006/0177257 A1
(43) Pub. Date: Aug. 10, 2006

(54) Elongated container

(76) Inventor: Garry Tsaur, Rowland Heights, CA (US)

Correspondence Address: JOE NIEH, 18760 E. AMAR ROAD #204, WALNUT, CA, 91789, US

(21) Appl. No.: 11/051,711

(22) Filed: Feb. 4, 2005

(51) Int. Cl. B43K 5/14; B43K 5/00

(52) U.S. Cl. 401/132; 401/205

(57) ABSTRACT

An elongated tubular container comprising an elongated tubular housing with a sealed end and an open end. A fluid is disposed in the elongated tubular container. The open end of the elongated tubular container is sealed with a sealing means comprising polyisobutylene, polybutenes, or a combination of polyisobutylene and polybutenes. Mineral oil may also be added to polyisobutylene, polybutenes or the combination of polyisobutylene and polybutenes to adjust its viscosity for any particular application.

### BACKGROUND—FIELD OF INVENTION

The present invention relates generally to a small elongated container for fluids. More specifically, the present invention relates to a small slender elongated container that encloses a fluid and minimizes its evaporation and contamination.

### BACKGROUND—DESCRIPTION OF RELATED ART

Containers for fluids come in various sizes and shapes and may be made of various materials. Various sealing means are used to seal the fluids in those containers. The sealing means may be a permanent seal such that upon opening the permanent seal would be destroyed and not resealable. The sealing means may also be resealable seal. Resealable sealing means may be in the form of a reclosable cap or plug.

However, for a small container, particularly a single use container, selection of a convenient and economical sealing means are very limited. Furthermore, for a small slender elongated container, such as a container for a sample perfume or unit-dose medication, an effective, economical, and disposable container with sealing means are even rarer.

The prior art has utilized liquid silicone, and oil, jelly, or cream with the addition of a preservative reagent or a bacterial retardant as the sealing means for the small slender elongated container. These liquid sealing means are effective to a certain extent. However, they are permeable and allow the enclosed fluid to evaporate, reducing the product's shelf life. Furthermore, they will dissolve into the fluid if the fluid has alcohol content in it. Therefore, containers sealed with these liquid sealing means have a limited shelf life and cannot be used to seal fluids containing alcohol as one of its components.

### BRIEF SUMMARY OF THE INVENTION

The present invention is an elongated tubular container with a sealed end and an open end. A fluid is disposed in the elongated tubular container. The open end of the elongated tubular container is sealed with a sealing means comprising polyisobutylene, polybutenes, or a combination of polyisobutylene and polybutenes. Mineral oil may also be added to polyisobutylene, polybutenes, or the combination of polyisobutylene and polybutenes to adjust its viscosity for any particular application.

### BRIEF DESCRIPTION OF THE DRAWINGS

FIG. 1 shows the preferred embodiment of the elongated container.

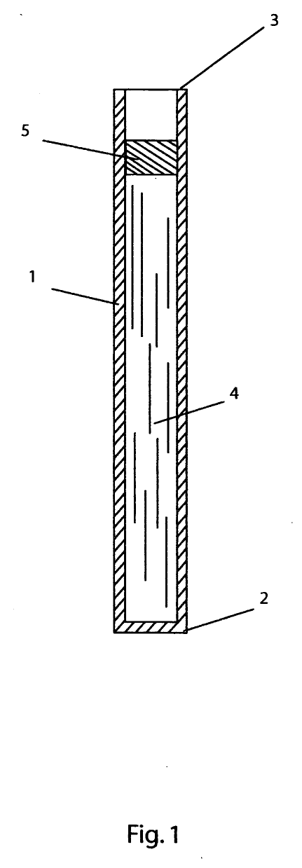

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

The present invention is an elongated container with a sealing means. In the preferred embodiment, the elongated container comprises of an elongated tubular container 1 with a sealed end 2 and an open end 3. The sealed end 2 may be formed by heat sealing one end of the elongated tubular container 1 or a cap or a plug may be affixed to one end of the elongated tubular container 1 to seal that end. In the preferred embodiment the elongated tubular container 1 is made of a plastic material such as polypropylene or polyethylene. The plastic elongated tubular container 1 may be formed by extrusion or injection molding. The elongated tubular container 1 may be rigid or compressible. In the preferred embodiment, the elongated tubular container 1 has a constant diameter throughout its length. A fluid 4 is disposed within the elongated tubular container 1. A sealing means 5 is disposed inside the elongated tubular container 1 at or near the open end 3 of the elongate tubular container 1.

The sealing means 5 comprises polyisobutylene, polybutenes, or a combination of polyisobutylene and polybutenes. Polyisobutylene has a very low gas-permeability and is stable and will not dissolve into a fluid with alcohol content. Polybutenes is a multipurpose oil and additive that is a clean, non-polluting lubricant that is non-toxic and exhibits little or no odor and is non-drying. Polybutenes may also be used as a viscosity index improver. In addition, mineral oil may be added to polyisobutylene, polybutenes, or the combination of polyisobutylene and polybutenes to adjust its viscosity for any particular application.

In the preferred embodiment, a flowable/resinous/high viscosity liquid polyisobutylene, polybutenes, or a combination of polyisobutylene and polybutenes is used as the sealing means 5. In the most preferred embodiment, the polyisobutylene, polybutenes, or a combination of polyisobutylene and polybutenes has a viscosity of over 500 cps (centi-poise).

An opening means may also be provided near the sealed end 2 of the elongated tubular container 1. The opening means may be a simple fracture line such as a score line formed on the elongated tubular container 1 that is rigid. Upon bending of the rigid elongated tubular container 1 near the fracture line while holding the open end 3 toward the ground, the elongated tubular container 1 would break open at the fracture line and allow entry of air into the elongated tubular container 1. The fluid 4 would naturally force its way, under gravitational force, through the liquid sealing means 5 and exit through the open end 3 of the elongated tubular container 1. The liquid sealing means 5 will yield to the fluid 4 through its center by opening a fluid flow path through its center and remain adhered to the interior walls of the elongated tubular container 1 due to its high viscosity.

An applicator may also be affixed to the open end of the elongated tubular container 1. The applicator may be a foam tip, a sponge tip, a cotton tip, or any other absorbent tip. Furthermore, the applicator may also be a formed applicator tip such as a nozzle. In addition, the applicator tip may also be a brush.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. An elongated container comprising:
an elongated tubular container with a sealed end and an open end;
a fluid disposed within said elongated tubular container; and
a sealing means is disposed inside said elongated tubular container at or near the open end of said elongate tubular container;
wherein said sealing means comprises polyisobutylene, polybutenes, or a combination of polyisobutylene and polybutenes.

2. An elongated container as in claim 1, wherein said elongated tubular container is made of a plastic material such as polypropylene or polyethylene.

3. An elongated container as in claim 1, wherein said the elongated tubular container has a constant diameter throughout its length.

4. An elongated container as in claim 1, wherein a mineral oil is added to said polyisobutylene, said polybutenes, or said combination of polyisobutylene and polybutenes to adjust its viscosity.

5. An elongated container as in claim 1, wherein said polyisobutylene, said polybutenes, or said combination of polyisobutylene and polybutenes has a viscosity of over 500 cps (centi-poise).

6. An elongated container as in claim 1, wherein an opening means is provided near said sealed end of said elongated tubular container.

7. An elongated container as in claim 6, wherein said opening means is a fracture line formed on said elongated tubular container.

8. An elongated container as in claim 1, wherein an applicator is affixed to said open end of said elongated tubular container.

9. An elongated container as in claim 8, wherein said applicator is a foam tip, a sponge tip, a cotton tip, an absorbent tip, a nozzle, or a brush.

10. An elongated container comprising:
an elongated tubular container with a sealed end and an open end;
an opening means provided near said sealed end of said elongated tubular container;
a fluid disposed within said elongated tubular container; and
a sealing means is disposed inside said elongated tubular container at or near the open end of said elongate tubular container;
wherein said sealing means comprises polyisobutylene, polybutenes, or a combination of polyisobutylene and polybutenes.

11. An elongated container as in claim 10, wherein said elongated tubular container is made of a plastic material such as polypropylene or polyethylene.

12. An elongated container as in claim 10, wherein said the elongated tubular container has a constant diameter throughout its length.

13. An elongated container as in claim 10, wherein a mineral oil is added to said polyisobutylene, said polybutenes, or said combination of polyisobutylene and polybutenes to adjust its viscosity.

14. An elongated container as in claim 10, wherein said polyisobutylene, said polybutenes, or said combination of polyisobutylene and polybutenes has a viscosity of over 500 cps (centi-poise).

15. An elongated container as in claim 10, wherein said opening means is a fracture line formed on said elongated tubular container.

16. An elongated container as in claim 10, wherein an applicator is affixed to said open end of said elongated tubular container.

17. An elongated container as in claim 16, wherein said applicator is a foam tip, a sponge tip, a cotton tip, an absorbent tip, a nozzle, or a brush.
